(19) United States
(12) Patent Application Publication
(10) Pub. No.: US 2015/0201045 A1
(43) Pub. Date: Jul. 16, 2015

(54) AUTOMATIC CONNECTION OF NODES TO A CLOUD CLUSTER

(71) Applicant: TRANSCIRRUS, Durham, NC (US)

(72) Inventors: Shashaankar Reddy KOMIRELLY, Raleigh, NC (US); Jonathan ARRANCE, Cary, NC (US)

(21) Appl. No.: 14/595,474

(22) Filed: Jan. 13, 2015

Related U.S. Application Data
(60) Provisional application No. 61/926,672, filed on Jan. 13, 2014.

(51) Int. Cl. H04L 29/06

(52) U.S. Cl. CPC H04L 69/16; H04L 67/42

(57) ABSTRACT

Method and System for connecting nodes in a cloud cluster, including creating a new client Transmission Control Protocol (TCP) socket on a new node and a new server TCP socket on a node utilizing Python technology, and exchanging a sequence of messages between the new client TCP socket and the new server TCP socket.

### CROSS-REFERENCE TO RELATED APPLICATIONS

This application claims priority to 61/926,672 filed on Jan. 13, 2014, which is herein incorporated by reference in its entirety.

### BACKGROUND

In order to add a new node, a system administrator may first install a supported operating system (OS) version (for example, Linux) on the new node, and then may check that all of the proper pre-requisite packages are installed and ready to go. Once the OS is installed and everything is stabilized, the system administrator may then log in, configure security, and get the proper packages for the computing environment. Nodes can be one of three basic types, purely compute, purely storage, or a hybrid of the two. Openstack is an example horizontally scaling, cloud computing environment, which may allow services, such as Nova compute, to be installed on dedicated nodes. Since Openstack can be an open environment, there may be a lot of node design flexibility and it may be up to the cloud architect to determine which services will live on the new node. Once the new node is purposed, the services may need to be configured to match the environment. Some environments may be simple and require little configuration, while other environments may be very complex and require multiple levels of network, stack, and physical system configuration. This configuration may be done using config files on the command line.

Configuring a new node as described above can be tedious, susceptible to errors and time consuming. It may be desirable to have an another protocol.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is an example illustration of a cloud computing environment;

FIG. 2 is an example flow diagram of the command traffic when adding a compute node to a cloud cluster; and

FIG. 3 is an example flow diagram of the command traffic when adding a storage node to a cloud cluster.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of embodiments of the present invention.

The conventional method of configuring a new node can be tedious, susceptible to errors and time consuming. An automated protocol can take much or all of the tedious, error prone and/or time consuming work (e.g., config file writing for the OS, network, and stack levels) out of the hands of the system administrator. For example, the automated protocol could enable a system administrator to dynamically add a new compute or storage node to a backend data network and add new resources to an Openstack cloud. Some embodiments of the automated protocol could enable a system administrator to track and monitor the node while it is in service. Embodiments of the automated protocol could also mark nodes when they are disconnected, or in a “fault” state. These and other features can help save time by allowing the system administrator to concentrate more on cloud operations and less on node and network monitoring.

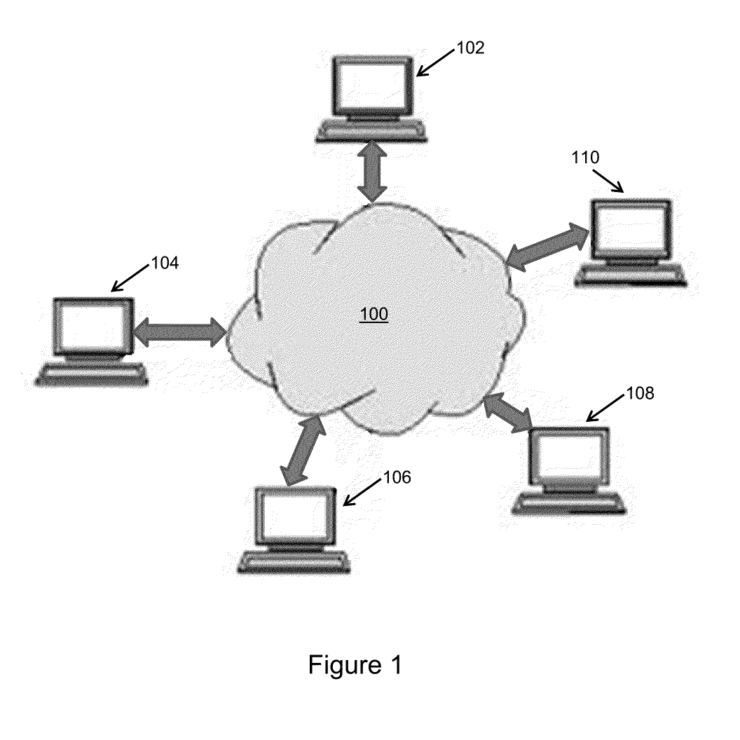

FIG. 1 illustrates an exemplary cloud computing environment with multiple nodes 102-110 coupled to a computing network 100. Each of the nodes 102-110 can be compute and/or storage nodes and can be located in multiple locations. The computer network 100 can enable any of the nodes to use the computing and storage capabilities of the entire network which can include the capabilities of the nodes 102-110 along with additional facilities accessible over the network 100.

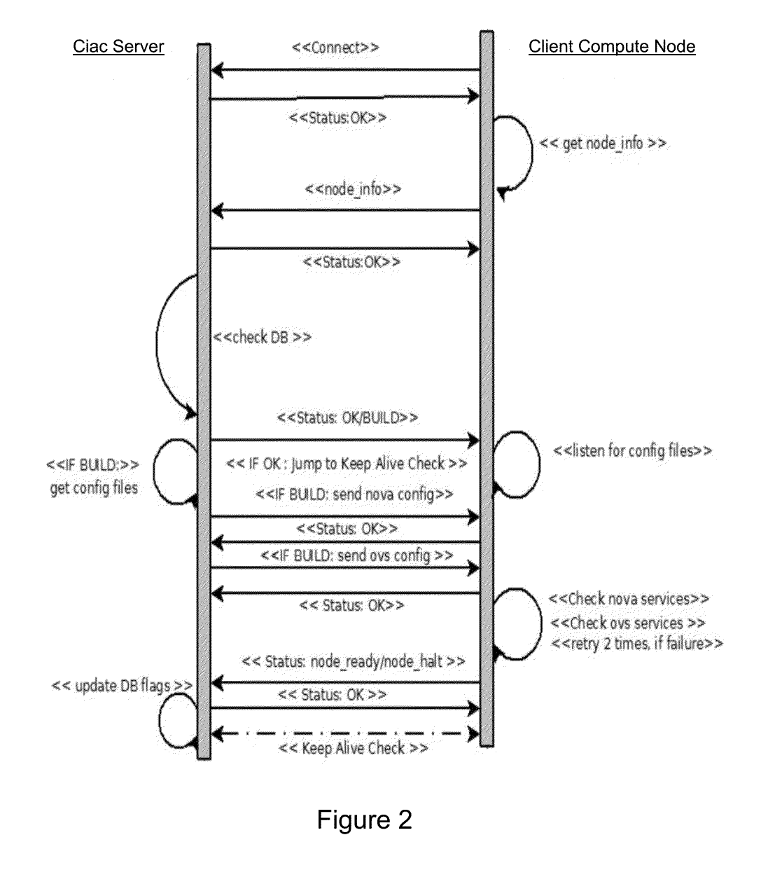

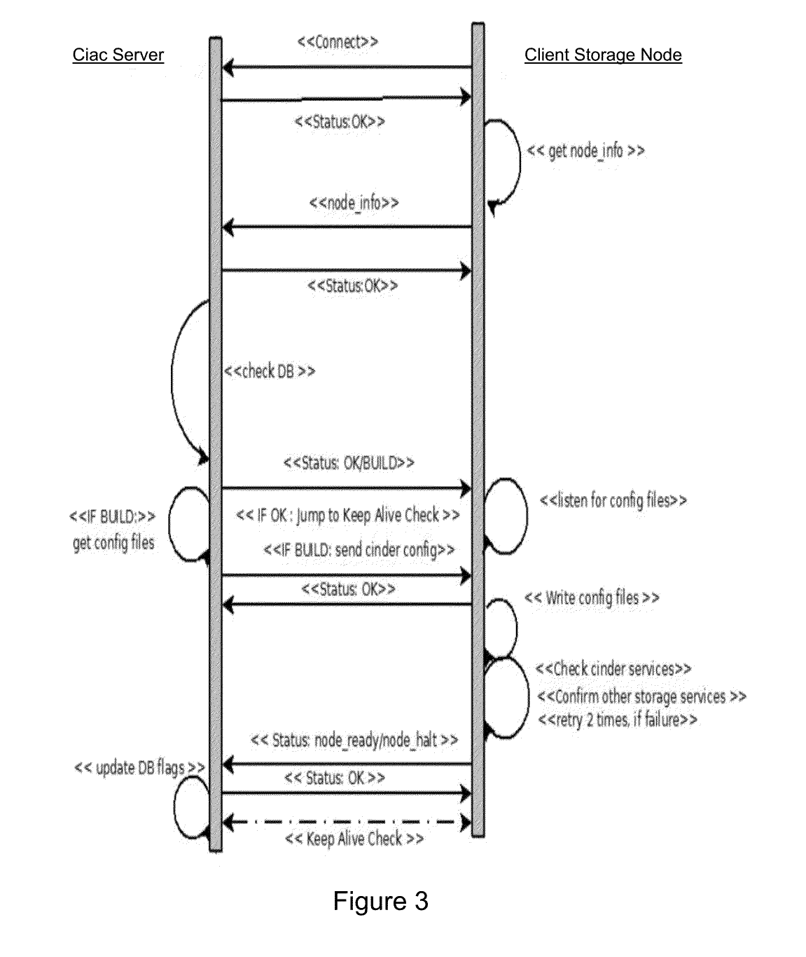

As networks expand, new storage and/or compute nodes can be added to provide increased capacity and capability while the cloud is in use. An exemplary automated process is illustrated in the flow diagrams of FIGS. 2 and 3 that can be used to add a new compute node and a new storage node, respectively, to a cloud cluster. During the boot up process of the new compute/storage node; a script running on the new node can extract the Centralized Infrastructure and Computing (CIAC) node Internet Protocol (IP) address from the Dynamic Host Configuration Protocol (DHCP) leases files, and then create a client Transmission Control Protocol (TCP) client socket on the new node. The newly created TCP Client socket on the new node can then connect to the server socket running on the CIAC node. The CIAC node can be listening on a specified port (for example, port number ‘6161’) for connection of a new node.

The automated node connection script is spanned across the CIAC node and the new storage/compute node. The script creates a Client TCP socket on the new compute/storage node and a server TCP socket on the CIAC node. An initial sequence of messages is exchanged between the new client and server sockets to confirm establishment of a connection, to send node information, and to configure the new node (if needed). After establishment of the connection, ‘keep alive’ messages can be sent to check the client server connection.

When the automated connection process receives control, it creates a client socket and establishes a TCP connection to the server socket running on the CIAC node. The CIAC node will have a server socket listening on a designated TCP port. After the TCP connection is successfully established between the client and server sockets, a CONNECT message is sent by the client node to the server. The server acknowledges the CONNECT message with a STATUS message with a value of ‘ok’.

The client node then sends a node information message to the server with configuration and connectivity information of the newly added node. The node information message can be a dictionary based “node_info” structure message including static configuration and connectivity information. The server acknowledges the node information message with a STATUS message with a value of ‘ok’. The server then performs necessary checks in the database and sends a STATUS message with a value of ‘ok’ or ‘build’ depending on the result of the checks in the database.

Upon reception of a STATUS ‘ok’ message from the server after the database search, the client node restarts all services and checks for running/up state. Then the client node can send ‘keep alive’ messages to the server informing about its connectivity status. Upon reception of a STATUS ‘build’ message from the server after the database search, the series of actions taken by the new node will vary depending on the node type.

As illustrated in FIG. 2, when a compute node receives a STATUS ‘build’ message from the server after the database search, the client compute node goes into listening mode for configuration files to be sent by the CIAC server socket. The CIAC server socket extracts configuration information from the database and sends it to the new compute node. The server can create a tag-length-value (TLV) based file content dictionary, for example using Python or other language, with a nova configuration file and an ovs configuration file. The CIAC server can first send the nova configuration file in TLV format and listen for an ‘ok’ acknowledgement from the client socket; then the CIAC server can send the ovs configuration file in TLV format and listens for an ‘ok’ acknowledgement from the client socket. Once both the nova and ovs configuration files have been received by the client socket, the automated connection process on the new node can write the configuration files into their respective file locations and then restart all services and check if they are running with no issues. The client node can send a STATUS message to the server with a value indicating whether there are any issues. If all the services are up and running with no issues, the client node can send a STATUS message with a value of ‘node_ready’ to the CIAC server socket. If any of the services are not running or have an issue starting, the client node can send a STATUS message with a value of ‘node_halt’ to the CIAC server socket. When the services are up and running with no issues, the new node can go into ‘keep alive’ check.

The control flow for a storage node is similar to a compute node except that the server socket sends a Cinder configuration to the new storage node instead of a compute node configuration. As illustrated in FIG. 3, when a storage node receives a STATUS ‘build’ message from the server after the database search, the client storage node goes into listening mode for configuration files to be sent by the CIAC server socket. The CIAC server socket extracts configuration information from the database and sends it to the new storage node. The server can create a tag-length-value (TLV) based file content dictionary with a cinder configuration file. The CIAC server sends the cinder configuration file in TLV format and listens for an ‘ok’ acknowledgement from the client socket. Once the cinder configuration file has been received by the client storage socket, the automated connection process on the new node can write the configuration files into their respective file locations and then restart all services and check if they are running with no issues. The client node can send a STATUS message to the server with a value indicating whether there are any issues. If all the services are up and running with no issues, the client node can send a STATUS message with a value of ‘node_ready’ to the CIAC server socket. If any of the services are not running or have an issue starting, the client node can send a STATUS message with a value of ‘node_halt’ to the CIAC server socket. When the services are up and running with no issues, the new storage node can go into ‘keep alive’ check.

The messages exchanged between the client and server sockets using the automated connection method can follow a dictionary format. A dictionary is a common data structure that includes items which can be of any form of data, and are typically stored in the array. Each item is usually associated with a unique key. The key can be used to retrieve an individual item and is usually an integer or a string, or any other value. Python allows nested dictionaries, list objects, lists within dictionaries and also dictionaries within lists, which provides flexibility to operate structures in a user defined way. The PERL scripting language also gives flexibility by forming dictionaries using an associative array. However, irrespective of any language supporting dictionary objects, wrappers can be implemented around list/arrays/hash maps to form a user defined way of forming dictionaries. This can be used to construct and parse new TLV format messages.

Messages can include three main parts: Type, Length, and Value. The Type field specifies the type of information being sent via socket messages, such as ‘node_info’, ‘connect’, ‘status’, etc. This can basically describe the type of packet or message being sent between the CIAC server and the storage/compute node. The Value field specifies a key-value pair, for example a python dictionary based key-value pair, for the information being exchanged between the client node and the server. The Value field is typically another dictionary, and it may be a list of dictionaries if multiple structures of information are being passed. The Length field specifies the number of elements being sent via this message. Typically the value in the Length field is the number of key value pairs in the Value field. Some example message formats are shown below.

### CONNECT Message Format:

{‘Type’: ‘connect’, ‘Length’:‘1’, ‘Value’: ‘connect’}

Here, ‘Type’ specifies the message type, ‘Length’ specifies the number of values in the ‘Value’ field, and ‘Value’ specifies a list of values being sent or lists of dictionaries, or a single dictionary with many key value pairs.

### STATUS ok Message Format:

{‘Type’: ‘status’, ‘Length’:‘1’, ‘Value’: ‘ok’}

Here, ‘Type’ specifies the message type, ‘Length’ specifies the number of values in the ‘Value’ field, and the ‘Value’ is ‘ok’.
‘node_info’ Message Format:

{‘Type’: ‘node_info’, ‘Length’: ‘1’, ‘Value’: {‘node_name’: ‘zbcd’,
‘node_type’: ‘cn’, ‘node_mgmt_ip’: ‘192.168.10.10’, ‘node_data_ip’:
‘172.16.10.10’, ‘node_controller’: ‘CIAC’, ‘node_cloud_name’:
‘cloud1’, ‘node_nova_zone’ : ‘’, ‘node_iscsi_iqn’: ‘’,
‘node_swift_ring’: ‘’ }}

Here, ‘Type’ specifies the message type of ‘node_info’. The ‘Length’ field specifies the number of node_info messages being exchanged between the sockets. In this case, the value of the ‘Length’ field is ‘1’. The ‘Value’ field is a dictionary of name value pairs that contain metadata of the new node inserted into the cloud system. The number of elements in the Value dictionary may vary depending on the data needed by the cloud controller to add the new node into its cluster.
Message Format with Two TLV Structures:

{‘Type’: ‘TLV’, ‘Length’: ‘2’, ‘Value’: [{‘Type’: ‘node_cfg’, ‘Length’:
‘3’, ‘Value’: ‘{‘key1: ‘value1’, ‘key2’, :‘value2’, ‘key3’: ‘value3’}’},
{‘Type’: ‘node_stats’, ‘Length’: ‘2’, ‘Value’: ‘{‘key4’: ‘value4’, ‘key5’:
‘value5’}’}] }

Here, ‘Type’ specifies that this is a TLV (tag-length-value) message, and ‘Length’ specifies the number of TLV structures that are embedded in the ‘Value’ field. The ‘Value’ field specifies a list of TLV structures ‘node_cfg’ and ‘node_stats’ that are passed between the sockets.

Some example message formats for the packets that can be transferred between the client and server sockets during the automated connection process are shown below.

status_ready = {‘Type’: ‘status’, ‘Length’: ‘1’, ‘Value’: ‘node_ready’ }
status_halt = {‘Type’: ‘status’, ‘Length’: ‘1’, ‘Value’: ‘node_halt’ }
keep_alive = {‘Type’: ‘status’, ‘Length’: ‘1’, ‘Value’: ‘keep_alive’ }

Some example messages for a compute node configuration are shown below. The compute node configuration file sent by the server socket on the CIAC node, can include a nova configuration, a compute configuration and an api configuration. The configuration files can be sent in the example format shown below; which includes file name, fie type, file owner, file permissions, and file contents. The whole message can be treated as a nested dictionary.

compute_conf = {
‘nova_conf’: {op' : ‘new’, ‘file_ owner’ : ‘nova’, ‘file_group’: ‘nova’,
‘file_perm’ : ‘644’, ‘file_path’: ‘/etc/nova’, ‘file_name’: ‘nova.conf’.
‘file_content’: [nova_con] }, ‘copm_conf’: {‘op’: ‘new’, ‘file_owner’:
‘nova’, ‘file_group’: ‘nova’, ‘file_perm’: ‘644’, ‘file_path’: ‘/etc/nova’,
‘file_name’: ‘nova-compute.conf’, ‘file_content’: [comp_con] },
‘api_conf’ : {‘op’: ‘append’, ‘file_owner’: ‘nova’, ‘file_group’:
‘nova’, ‘file_perm’: ‘644’, ‘file_path’: ‘/etc/nova’, ‘file_name’:
‘api-paste.ini’, ‘file_content’: [api_con]}}

Some example messages for a storage node configuration are shown below. The storage node configuration file sent by the server socket on the CIAC node, can include a cinder configuration and an api configuration. The configuration files can be sent in the example format shown below; which includes file name, fie type, file owner, file permissions, and file contents. The whole message can be treated as a nested dictionary.

storage_conf = {
‘cinder_conf’ : {op‘’: ‘new’, ‘file_owner’: ‘cinder’, ‘file_group’:
‘cinder’, ‘file_perm’: ‘644’, ‘file_path’: ‘/etc/cinder’, ‘file_name’:
‘cinder.conf’, ‘file_content’: [cin_con] }, ‘api_conf’ : {‘op’:‘append’,
‘file_owner’: ‘cinder’, ‘file_group’: ‘cinder’, ‘file_perm’: ‘644’,
‘file_path’: ‘/etc/cinder’, ‘file_name’: ‘api-paste.ini’, ‘file_content’:
[api_con] }}

TLV is tag-length-value encoding, and it is often referred to by its original name, type-length-value. The first field specifies the ‘type’ of data being processed, the second field specifies the ‘length’ of the value field, and the third field contains a ‘length’ amount of data representing the ‘value’ for the ‘type’. Multiple pieces of data can be transmitted in the same message by appending more triplets to a previously existing message. TLV is a way of storing data to facilitate quick parsing of the data, and it is typically used as an easy way to process data without a lot of extra overhead.

The TLV format may include:
Relatively compact encoding format,
Relatively simple to parse,
TLV sequences are easily searched using generalized parsing functions,
New message elements which are received at an older node can be safely skipped and the rest of the message can be parsed,
TLV elements can be placed in any order inside the message body,
TLV elements are typically used in a binary format which makes parsing faster and the data smaller, and
Easy to generate XML from TLV for human inspection.

A disadvantage of TLV messages may be that they are not directly human readable. However, if the data is converted to hexadecimal it is only moderately difficult to read.

In nested TLV messages, the TLV count field in the api message accounts for the top level TLVs but not the nested TLVs. The same TLV structure can be used multiple times within the same message depending on the context of the nested TLVs. The Length field in any ‘parent’ TLV of the nested TLV message counts the bytes in all of its nested TLVs.

TLV format messages can be used for communication between storage/compute nodes added in a cloud cluster. A new way can be used of nesting messages that include Type, Length and Value fields. The Value field in nested TLV messages can be implemented in a more efficient way that takes advantage of the dictionary object support available in some languages. When messages are exchanged between any two components over the socket interface, the TLV messages may be serialized into a text format and sent over the network. At the receiving end these TLV messages can be de-serialized. Hence, the message retains the original format while sending.

An alternative new approach is to not use generic ‘Type’ messages, which deviate from the traditional implementation of TLV messages. The difference is illustrated in the following example. A traditional approach of representing a TLV message to make a telephone call could use two message elements, ‘command_c’ and ‘phoneNumberToCall’. Here every field in the message is separated by a slash (“/”).

command_c/4/makeCall_c/phoneNumberToCall_c/8/‘722-4246’

In traditional representation, this message includes two TLV messages back to back. In the first TLV message, ‘command_c’ is the Type, ‘4’ is the Length (typically in bytes) of the command, and ‘makeCall_c’ is the actual command to be executed. The second TLV message includes ‘phoneNumberToCall_c’ as the Type, ‘8’ as the Length and finally the number to call which is eight characters in total (typically each character is represented in a byte). Here, ‘command_c’, ‘makeCall_c’ and ‘phoneNumberToCall_c’ are integer constants, and ‘4’ and ‘8’ are the lengths of the Value fields, respectively.

A later version of the system, version 2, that uses the traditional TLV approach could add a new field containing the calling number as shown below:

command_c/4/makeCall_c/callingNumber_c/14/‘1-613-715-9719’/
phoneNumberToCall_c/8/‘722-4246’

Here the length of the ‘command_c’ type TLV message is still ‘4’ (bytes), as the actual command ‘makeCall_c’ is still represented in four bytes of memory. This is followed by a new embedded TLV message ‘callingNumber_c’ which is of Length ‘14’ as it contains fourteen characters in its Value field. Finally, the ‘phoneNumberToCall_c’ message is as represented in version 1.

An earlier version system which received a message from a version 2 system would first read the ‘command_c’ element and then read an element of type ‘callingNumber_c.’ The earlier version system does not understand ‘callingNumber_c’ so the Length field is read (i.e. ‘14’) and the system skips forward fourteen bytes to read ‘phoneNumberToCall_c’ which it understands, and message parsing continues.

A new TLV approach for representing the above message in the earlier version of the system can represent the two message elements as:

{Type: ‘command_c’, Length: ‘1’, Value: ‘makeCall_c’}, {Type:
‘phoneNumberToCall_c’, Length: ‘1’, Value: ‘722-4246’}

In this approach, the message may be represented in dictionary format. Multiple commands can be embedded in a single Type ‘command_c’ TLV message by varying the Length field since here Length signifies the number of value elements but not the number of bytes occupied by the value field. Hence, passing multiple commands via the same message with this new TLV approach can be done by simply using, for example:

{Type: ‘command_c’, Length: ‘2’, Value:{command1:‘makeCall_c’,
command2:‘joinConference’}}

The same message when represented in the traditional TLV approach may have included two TLV messages for each command.

command_c/4/makeCall_c/command_c/4/joinConference

which requires parsing two commands separately by the receiving system. Here, the length of the second ‘command_c’ message is ‘4’ which differs from the Length in the new TLV format. In the traditional approach the Length field specifies the number of bytes it requires to represent the Value field, whereas in the new TLV message format, Length specifies the number of values in the Value field.

With the new TLV approach, a single parsing of the Type field can access multiple values as specified by the Length field since Length does not signify the actual length or number of bytes occupied by the Value field. Thus, the new TLV approach slightly changes the meaning of the Length field and uses a dictionary structure to hold the values passed, which gives more flexibility and efficiency in accessing and parsing the values.

The new TLV format messages may perform some or all of the following, as compared to the traditional TLV format messages:
a) Structuring the Type, Length and Value fields as dictionary objects gives flexibility to do predefined/language supported operations.
b) Multiple elements can be passed in a single Type message, specifying the appropriate number in the Length field which reduces the overhead to represent multiple TLV messages for each and every elements passed.
c) Encapsulating the multiple members in the form of dictionary objects adds more flexibility in terms of operation and also relieves the programmer for any type checking
d) Limiting the number of TLV messages required to pass similar elements between two components exchanging messages.
e) Reducing the parsing task for the receiving system as the number of TLV messages are reduced.
f) New TLV format assumes change in semantics of the Length field to specify the number of Value field elements.
g) Scales down the programmers and receiving system's burden to process and keep track of the number of bytes to read in each Value field.
h) Size of the entire message encapsulating multiple elements is less than representation of the same message in traditional TLV format which reduces memory requirements to store the message.
i) Debugging becomes easier and chances of programming errors is reduced as the control flow parsing is not based on byte by byte reading. Dictionary based or list based objects abstract low level accesses, and provide flexibility in terms of parsing. Also, in traditional TLV messages, control flow jump is based on recognition of Type message at the receiving system; whereas in new TLV messages it is not a jump of control flow for the required value in the Length field, but the program control will access the next element in the list or dictionary or skip the entire message based on the Type field.
   For these multiple elements passed via a single TLV message in the new approach, the messages may all be of functionally similar types since the Type field is generic to all the elements passed in a single TLV message.

Similarly for the message of the version 2 system using the new TLV approach, the extra parameter included in the message, ‘callingNumber_c’, can be represented as follows:

{Type: ‘command_c’, Length: ‘1’, Value:‘makeCall_c’},
{Type: ‘callingNumber_c’, Length: ‘1’, Value: ‘1-613-715-9719’},
{Type: ‘phoneNumberToCall_c’, Length: ‘1’, Value: ‘722-4246’}

In a similar way as done for traditional messages, an earlier version receiving system can just ignore the second TLV message as soon as it parses ‘callingNumber_c’. Here, in of the new TLV format, the receiving system does not need to reference the Length field and skip a specified number of bytes, but it may just access the next dictionary object in the list.

The new TLV approach can represent the above three TLV messages in a more efficient way using a special generic message Type of ‘TLV’, for example:

{Type: ‘TLV’, ‘Length: ‘3’, Value: [{Type: ‘command_c’, Length: ‘1’,
Value:‘makeCall_c’}, {Type: ‘callingNumber_c’, Length: ‘1’,
Value:‘1-613-715-9719’}, {Type:‘phoneNumberToCall_c’, Length: ‘1’,
Value:‘722-4246’} ] }

The above nested TLV format message using the new TLV approach, may be highly efficient in parsing compared to the traditional TLV approach since it may not require byte by byte reading. When the receiving system encounters a Type ‘TLV’ message, it may checks the Length field to see how many TLV structures are passed in this message. This new TLV approach of representing TLV messages considers the Value field as a dictionary object list in the case of nested TLVs. Hence, the Value field may be a list of all three messages passed as TLV messages. The same nested TLV message when represented in traditional TLV format map appear as follows:

TLV/40/command_c/4/makeCall_c/callingNumber_c/14/‘1-613-715-
9719’/phoneNumberToCall_c/8/‘722-4246’

Here the message Type is ‘TLV’ and the length is presumed to be 40 bytes (typically) to represent the entire message from ‘command_c’ to ‘phoneNumberToCall_c’. The Length field may vary depending on the system and the memory requirements to represent the Value field.

In the above traditional TLV format message, the first two fields specify the Type and Length, which specifies the message type as TLV and the Length as the number of bytes to read/consider for parsing the rest of the message. The receiving system should then read the next forty bytes as the Value field embedding the three TLV messages.

The new TLV format may, with respect to nested TLV messages, do some or all of the following:
a) Represent nested TLVs in Value field of the message as lists. So don't clog up network reliability.
b) Provide a processor efficient way of parsing objects using direct memory access with object references rather than byte by byte reading which consumes a greater number of CPU cycles. Frees CPU to actually do computing instead of processing messages.
c) Reduce chances of program error by not directly accessing elements stored using their addresses. When accessing the Value field in the traditional TLV approach, there are more chances of accessing memory bytes that are not part of the message which can cause system failures, or not accessing a few bytes of the Value field which can cause system errors. Once we get everything locked down on both ends, if we know the type of length value of a node information message. If it is anything but “2” we know it is wrong. So we can disregard anything that comes in of the wrong length. Or something on core node is messed up.
d) Provide a more secure way of encoding and decoding the parameters to be passed. Put into Python dictionary. We don't need to worry about data getting corrupted. If we know it should be length of 1 and it is a 2, then something is wrong. Python dictionary tells you what things should be. Dictionary makes it easy to decode on other side.
e) Reduce overhead of keeping track of the number of bytes of memory each Value field occupies. Because have Python dictionary.
f) Simplify the programmer's job in representing the Length as the number of elements instead of the size in bytes of the Value field. Because have Python dictionary.
g) Structure the Value field as a list object gives flexibility for various predefined or language provided operations.
h) Implement security policies on TLV message being exchanged that can be read by only specific authorized receiving systems. Since we do have these known types. Compute node type message sent to storage node will ignore it. We can lock that out further by specialty node that can't just go on the gray market of send to someone else. Can't make copies and sell somewhere else.
i) Provide flexibility to employ encryption of sensitive TLV messages which can be parsed or understood by authorized receiving systems. Other systems that try to parse these messages may receive corrupt data which may lead to system failure. Use SSL to tie together and doesn't impact the TLV message (garble or make is unreadable).

An example TLV format connect message can be as follows:

Type: command/Length:6/Value: connect

Traditionally TLV messages are parsed as follows:
1) First the system reads the Type field; which in this case is ‘command’
2) Then, the system checks the Length field; which in this case is ‘6’
3) Finally, the system reads the next six (value of Length field) bytes as the Value field in the TLV message to parse the function, which in this case is ‘connect’.
   The new TLV message approach may not use a generic Type field making the system to parse the Length and Value fields. The new TLV format may directly encode the command as ‘Type’ for efficiency and reduce the receiving system's task to parse. The connect message may be used as a connection initiation message between a server node and a compute/storage node, and can be extended to connect various components that would interact among themselves.

An example new TLV format status halt message can be of the format:

Type: ‘status’,/Length: ‘1’,/Value: ‘node_halt’

Whereas the traditional TLV status_halt message can be of the format:

Type: command/Length: 9/Value: node_halt

Systems implementing the traditional TLV format of the above message may need to parse the Type and Length fields and read the next Length number of bytes to retrieve the Value field in the TLV message to understand the message passed. The new TLV format messages may encode the entire TLV message in a dictionary, which may give efficient parsing of Type and Length fields and may directly use the Value field rather than placing a strict byte by byte read as in the traditional approach. In addition, if multiple arguments are passed in the Value field, the traditional TLV format may require that multiple TLV messages be embedded inside the Value field with one TLV message for each single argument. For example, in the traditional TLV format:

Type: command / Length: 2 / Value: (Type: command1 / Length: 9 /
Value: node_halt, Type: command2 / Length:10 / Value: node_ready)

The new TLV format may give a more robust and efficient way of embedding multiple arguments in the form of a dictionary, giving more flexibility to encode and decode the message. For example, in the new TLV format both of these messages can be combined as:

{Type: status, Length: 2, Value:{command1: node_halt, command2:node_ready}}

An example ‘node_info’ message in the new TLV format can be as follows:

{Type: ‘node_info’, Length: ‘1’, Value: {‘node_name’: ‘zbcd’,
‘node_type’: ‘cn’, ‘node_mgmt_ip’: ‘192.168.10.10’, ‘node_data_ip’:
‘172.16.10.10’, ‘node_controller’: ‘CIAC’, ‘node_cloud_name’:
‘cloud1’, ‘node_nova_zone’ : ‘’, ‘node_iscsi_iqn’: ‘’,
‘node_swift_ring’: ‘’ }}

In the traditional TLV format, the above message can be as follows:

Type: node_info / Length: 90 / Value: (Type: node_name / Length: 4 /
Value: zbcd , Type: node_type / Length: 2 / Value: cn , Type:
node_mgmt_ip / Length: 13 / Value: 192.168.10.10 , Type:
node_data_ip / Length: 12 / Value: 172.16.10.10 , Type:
node_controller / Length: 4 / Value: CIAC, Type: node_cloud_name /
Length: 6 / Value: cloud1, Type: node_nova_zone / Length: 0 / Value: ,
Type: node_iscsi_iqn / Length: 0 / Value: , Type: node_swift_ring /
Length: 0 / Value: )

The above message formats show that the traditional TLV message approach may use a generic Type as ‘node_info’ and Length specifying the number of bytes inside the Value field. In addition, each chunk of data inside the Value field is a TLV message for each and every name-value pair. The new TLV message format may use a simpler format with Value set to ‘1’ which may imply that only one ‘node_info’ structure is being sent via this message. In this approach, the Length field may not need to be specified for each and every name-value pair inside the Value field because it may leverage the dictionary functionality by encoding all of the variables in a single dictionary with a length that is implicit and may provide an easy way to access the variable by just indexing from ‘0’ to length of the dictionary.

While the nodes described above are described as capable of being compute and/or storage nodes, in some embodiments other nodes capabilities may also be used. For example, hybrid nodes, which may nodes that perform storage and computation in the same node, may be used. In addition, General Processing Unit (GPU) nodes, which may be high performance compute nodes utilizing GPUs (e.g., for advanced number crunching). Additionally, Non-Volatile Memory (NVM) flash storage nodes, which may be used for high end (input/output) 10 applications, may be used.

A hybrid node may have a balance of compute, memory, and Central Processing Unit (CPU) resources in it and may be used in conjunction with, or as a replacement for, a separate compute and storage node. In this case, TLV messages for both compute and storage node configuration may be sent by the CIAC node to the hybrid node. The node type identifier may be used as before to identify the node as a hybrid node to the CIAC node.

In the case of a GPU and NVM flash nodes, a new node type may need to be established for each node. The GPU node may act as a high performance compute resource for math intensive applications, once the node establishes a connection to the CIAC node, and the configuration may be similar to a standard compute node configuration, with the exception of a flag being set that may prevent standard Volatile Memories (VMs) from being brought up on it. The NVM flash node may be used for 10 intensive applications, and may be configured in much the same way that a standard storage node is configured, with the exception of the GlusterFS file systems perhaps not being able to be expanded to these nodes. The TLV messages passed to the NVM flash node may follow the structure used to configure other TransCirrus nodes. A new file system may become available and be automatically integrated into the cloud resources that may be used to service applications.

While example embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method of connecting nodes in a cloud cluster, comprising:
creating a new client Transmission Control Protocol (TCP) socket on a new node and a new server TCP socket on a node utilizing Python technology; and
exchanging a sequence of messages between the new client TCP socket and the new server TCP socket.

2. The method of claim 1, further comprising creating a new node.

3. The method of claim 2, wherein the creating a new node comprises:
extracting a node Internet Protocol (IP) address from a leases file related to the new server TCP socket running on the node utilizing Python technology; and
connecting the newly created TCP client socket to the new server TCP socket.

4. The method of claim 1, further comprising:
when an automated connection process receives control, establishing a TCP connection from the new client TCP socket to the new server TCP socket;
sending a connect message between the new client TCP socket and the new server TCP socket; and
receiving an acknowledgment of the connect message.

5. The method of claim 1, further comprising:
sending a node information message to the new server TCP socket with configuration and connectivity information for the new node;
receiving acknowledgment of configuration and connectivity information for the new node; and
allowing checks and changes associated with the new node in a database.

6. The method of claim 5, wherein:
completing a node build action for the new node when a build message is received.

7. The method of claim 5, wherein the node information message is dictionary based.

8. The method of claim 7, wherein a dictionary based node information message comprises static configuration and/or connectivity information.

9. The method of claim 1, wherein the exchanging is performed to: confirm establishment of a connection; to send node information; or to configure the new node; or any combination thereof.

10. The method of claim 1, wherein the new node comprises: a compute node, a storage node, a hybrid node, a General Processing Unit (GPU) node, or a Non-Volatile Memory (NVM) node, or any combination thereof.

11. The method of claim 5, wherein the checks and changes associates with the new node are facilitated because information for the new node is stored in one database.

12. The method of claim 1, wherein tag-length-value (TLV) format messages are used for communication between nodes in the cloud cluster.

13. The method of claim 1, wherein the tag-length-value (TLV) format messages are nested TLV format messages so that multiple elements are communicated in a single TLV format message.

14. The method of claim 13, wherein the TLV format messages are structured as dictionary objects to provide flexibility to do predefined language supported operations.

15. The method of claim 13, wherein a change in semantics of the Length field to specify a number of Value field elements is utilized.

16. The method of claim 13, wherein a size of a nested TLV format message is less than a size of a non-nested TLV format message so that memory requirements to store the message are reduced.

17. The method of claim 13, wherein the nested TLV format messages reduce a system's burden to account for a number of bytes to read in each Value field as compared with a non-nested TLV format message.

18. A system of connecting nodes in a cloud cluster, comprising:
a node using Python technology for creating a new server Transmission Control Protocol (TCP) socket; and
a new node for creating a new client TCP socket;
wherein a sequence of messages is exchangable between the new client TCP socket and the new server TCP socket.
